(19) United States
(12) Patent Application Publication
(10) Pub. No.: US 2007/0237367 A1
(43) Pub. Date: Oct. 11, 2007

(54) Person verification apparatus and person verification method

(75) Inventors: Hiroshi Yamato, Amagasaki-shi (JP); Yuichi Kawakami, Nishinomiya-shi (JP)

Correspondence Address: SIDLEY AUSTIN LLP, 717 NORTH HARWOOD, SUITE 3400, DALLAS, TX, 75201, US

(73) Assignee: KONICA MINOLTA HOLDINGS, INC.

(21) Appl. No.: 11/700,202

(22) Filed: Jan. 30, 2007

(30) Foreign Application Priority Data
Feb. 7, 2006 (JP) 2006-029521

(51) Int. Cl. G06K 9/00

(52) U.S. Cl. 382/118; 382/115

(57) ABSTRACT

By retaining the history of past verification judgment as verification information, and, based on this verification information, at the time of every verification judgment, by determining the threshold value that becomes the reference for judgment, and by updating the verification information, a judgment threshold value suitable for the respective biometric information is set.

This application is based on Japanese Patent Application No. 2006-29521 filed on Feb. 7, 2006, in Japanese Patent Office, the entire content of which is hereby incorporated by reference.

### BACKGROUND OF THE INVENTION

1. Field of the Invention

The present invention relates to person verification apparatuses and person verification methods that carry out authentication of a person by comparing the biometric information acquired from a person with the registered biometric information.

2. Description of the Related Art

In recent years, along with the progress of the advanced information society, person authentication using code numbers and passwords is being used widely for permitting entrance to a facility giving importance to security, or to log in to an information system only for the person having the specific authority.

However, code numbers or passwords have the danger of being leaked or stolen. Once a code number or a password is known, it is possible for anybody to impersonate the specific person.

On the other hand, compared to these, the need is increasing for person authentication technology that authenticates a person based on biometrics information unique to the person such as finger prints, face, iris, hand geometry, etc., that are in principle very difficult to impersonate.

However, in the authentication technology of authenticating a person based on biometric information, there are advantages and disadvantages in terms of the authentication performance depending on the biometric information used, and when deciding which one to select, it is necessary to select based on various aspects such as the cost and safety, convenience, social acceptability, etc.

In general, among the authentication technologies using biometric information that has a high social acceptability, compared to the authentication technology using biometric information that has a low social acceptability, the technology that is superior in terms of comfortableness is inferior in its authentication performance. A technology being inferior in authentication performance means that it is not possible to identify the correct person from other persons with a sufficient accuracy. This fact has been a barrier for applying biometric information to a person authentication system.

For example, in order to realize a high security using face image recognition that has a high social acceptability, it is necessary to propose a method that can not only increase the rate of authenticating the correct person as the person himself or herself (the correct person acceptance rate), but also to maintain at a sufficiently high level the rate of rejecting persons other than the correct person (the wrong person rejection rate).

Among the general authentication technologies at present, it is very common to compare and collate the image of the person under test with the registered data in a prescribed feature space thereby obtaining the degree of similarity, and to judge whether or not the person under test is the correct person of the registered data depending on whether or not this degree of similarity is within a prescribed threshold value.

However, when considered by keeping fixed the threshold value which becomes the reference for judgment, although the probability of rejecting other persons becomes high if the threshold value is set low, at the same time even the probability of rejecting the correct person also becomes high. On the other hand, if the threshold value is set high, even though the correct person acceptance rate can be made high, it becomes easy for even other persons to be accepted.

In contrast with this, a technology has been proposed in which, when the wrong person rejection rate is given priority and it happens that the correct person is rejected, re-authentication is possible, under some prescribed conditions, using some other method such as ID or password, etc., (see, for example, Patent Document 1).

In Patent Document 1, a system has been proposed in which, when the person who is the person under test has been rejected in person authentication, if the authentication rate up to the previous time exceeds a prescribed threshold value, the authentication can be made using an ID card. Because of this, the wrong person rejection rate is kept at a sufficiently high level, and also, it is possible to correct even if the correct person acceptance rate decreases and the correct person is not authenticated.

However, this has not been an essential measure of achieving both correct person acceptance and wrong person rejection. The actual values of correct person acceptance rate and wrong person rejection rate vary with the threshold value that becomes the reference for judgment, and it is necessary to adjust this. However, the optimum state differs for each biometric information of each person, and fundamentally it is desirable to adjust individually to suit these.

In view of this, a technology of setting the threshold value that becomes the reference for judgment for each person or for each group (see, for example, Patent Document 2).

In Patent Document 2, by using a threshold value of judgment determined for each person or for each group, sufficient correct person acceptance rate has been acquired. Because of this, it is also possible to take care of the fact that the appropriate threshold value differs for each person, that is, for every biometric information.

However, even in this case, the determined threshold value is one whose range has been set under the authority of the user, and is not one that guarantees optimality.

In view of this, a technology has been proposed that considers a case in which it is difficult to achieve both correct person acceptance rate and wrong person rejection rate, that is, considering the presence of another person with a high degree of similarity, and, in the case of collation with that person having a high degree of similarity, changes the recognition conditions (see, for example, Patent Document 3).

In Patent Document 3, the issue of authentication in the collation mode of carrying out collation with all the dictionary information registered in a dictionary storing section (this is cased the 1-to-N collation mode). In order to solve this issue, the persons who have a high possibility of being recognized wrongly, that is, persons with a high degree of similarity are identified, and data is acquired again after changing the recognition conditions so that the degree of similarity expressing the correct person with respect to those wrong persons with a high degree of similarity becomes most distant. Because of this, it becomes difficult for confusion with wrong persons to occur.

However, by acquiring again the data, it is not certain that the correct person becomes distant from the specific persons with a high degree of similarity. If the data is to be changed, instead of being distant from wrong persons, it is fundamentally important to question whether the correct person's features are being expressed in a most average manner.

Patent Document 1: JP-A No. 2000-200213 (Hereinafter, JP-A refers to Japanese Patent Publication Open to Public Inspection)

Patent Document 2: JP-A No. 2004-252819

Patent Document 3: JP-A No. 2005-182184

As has been explained above, although in the technology of Patent Document 1, considering the rate of authentication, it is possible to carry out authentication again by using ID, etc., other than the biometric information, it is not possible to have any effect on the accuracy of collation judgment such as the correct person acceptance rate or the wrong person rejection rate.

Although in the technology of Patent Document 2, by setting the threshold value of judgment for each biometric information of a person or of a group, it is possible to acquire sufficient correct person acceptance rate, since the threshold value is set by the user, it cannot be said that optimization has been done including the wrong person rejection rate.

Although in the technology of Patent Document 3, for the presence of wrong persons with a high degree of similarity, that is, persons in whose case it is difficult to achieve both correct person acceptance rate and wrong person rejection rate, it is possible, by acquiring again and replacing the data of the correct person, to lower the degree of similarity and to make it difficult to confuse a wrong person for the correct person, there is no guarantee that by acquiring the data again the correct person becomes distant from a person of a high degree of similarity.

### SUMMARY OF THE INVENTION

The purpose of the present invention is to provide a person verification apparatus and a person verification method that solves the above problems, improves the accuracy of verification judgment in person verification using biometric information, and can maintain sufficiently high correct person acceptance rate and sufficiently high wrong person rejection rate.

In order to solve the above problems, the present invention has the following features.

1. A person verification apparatus comprising:

a first biometric information acquiring section for acquiring a first biometric information from a person who is a target of person verification;

a storage section for storing information necessary to verify the person;

a second biometric information acquiring section for acquiring a second biometric information and past verification information corresponding to the second biometric information stored in said storage section,

a threshold value determining section for determining a threshold value to be used in verification judgment based on the past verification information; and

a verification judgment section for carrying out verification judgment by comparing the degree of similarity between the first biometric information acquired by said first biometric information acquiring section and the second biometric information acquired by said second biometric information acquiring section with the threshold value determined by said threshold value determining section.

2. The person verification apparatus according to item 1, further comprising:

a verification information updating section,

wherein said verification information updating section updates past verification information corresponding to the second biometric information stored in said storage section, based on a current result of verification judgment by said verification judgment section.

3. The person verification apparatus according to item 1, wherein said threshold value determining section determines the threshold value based on the past verification information acquired by said second biometric information acquiring section from said storage section before carrying out verification judgment by said verification judgment section.

4. The person verification apparatus according to item 1, wherein said threshold value determining section determines the threshold value to be used at the time of next verification judgment based on the verification information, that was updated based on a result of verification judgment, after a verification judgment carried out by said verification judgment section.

5. The person verification apparatus according to item 1, wherein the past verification information corresponding to the second biometric information is stored in said storage section relating to the second biometric information, and the past verification information includes at least one of number of past verification trials for the second biometric information, number of past verification successes for the second biometric information, number of past verification failures for the second biometric information, past rate of verification success for the second biometric information, information representing history of threshold value, or information that can be converted mutually with these.

6. The person verification apparatus according to item 5, wherein said threshold value determining section determines the threshold value according to the past rate of verification success as the verification information stored in the storage section.

7. The person verification apparatus according to item 5, wherein said threshold value determining section determines whether or not to correct the threshold value according to the history of past threshold value as the verification information stored in the storage section.

8. The person verification apparatus according to item 1, wherein said storage section stores a plurality of second biometric information corresponding to a specific person and said verification judgment section carries out verification judgment to the first biometric information using the corresponding plurality of second biometric information.

9. The person verification apparatus according to item 8, wherein said threshold value determining section, when there is a second biometric information in the plurality of second biometric information from which appropriate threshold value can not be determined, determines to delete the second biometric information.

10. The person verification apparatus according to item 9, wherein said storage section stores candidates for second biometric information, and further comprising:

a biometric information registering and updating section to register the candidates for second biometric information as new second biometric information when said threshold determining section determines to delete.

11. The person verification apparatus according to item 1, wherein the first biometric information and the second biometric information are based on facial images.

12. A person verification apparatus comprising:

a threshold value determining section for determining a threshold value to be used in verification judgment;

a verification judgment section for carrying out verification judgment by comparing a first biometric. information acquired from a person who is a target of person verification and a second biometric information registered in advance with the determined threshold value; and

a verification information updating section for registering verification information for use in upcoming verification judgment based on a result of current verification judgment by said verification judgment section, wherein the verification information is registered relating to the second biometric information.

13. The person verification apparatus according to item 12, wherein the threshold value determining section determines threshold value to be used in verification judgment based on the registered verification information.

14. A person verification method comprising steps of:

acquiring a first biometric information from a person who is the target of person verification;

acquiring a second biometric information and past verification information corresponding to the second biometric information stored in a storage section;

determining a threshold value to be used in verification judgment based on the past verification information; and

carrying out verifying judgment by comparing the degree of similarity between the first biometric information and the second biometric information with the determined threshold value.

15. The person verification method according to item 14, further comprising:

updating past verification information corresponding to the second biometric information stored in the storage section based on a result of verification judgment by the carrying out step.

16. The person verification method according to item 14, wherein in the threshold value determining step, determine the threshold valued based on the past verification information acquired by the second biometric information acquiring step before carrying out verification judgment in the carrying out step.

17. The person verification method according to item 14, wherein in the threshold value determining step, determine the threshold value to be used at the time of next verification judgment based on the verification information, that was updated based on a result of verification judgment, after a verification judgment carried out by said verification judgment section.

18. The person verification method according to item 14, wherein the past verification information corresponding to the second biometric information is stored in the storage section relating to the second biometric information, and the past verification information includes at least one of number of past verification trials for the second biometric information, number of past verification successes for the second biometric information, number of past verification failures for the second biometric information, past rate of verification success for the second biometric information, information representing history of threshold value, or information that can be converted mutually with these.

19. The person verification method according to item 18, wherein in the threshold value determining step, determine the threshold value according to past rate of verification success based on the verification information stored in the storage section.

20. The person verification method according to item 18, wherein in the threshold value determining step, determine whether or not to correct the threshold value according to the history of past judgment threshold value based on the verification information stored in the storage section.

21. The person verification method according to item 14, wherein the storage section stores a plurality of second biometric information corresponding to a specific person, and in the verification judgment step, carry out verification judgment to the first biometric information using the corresponding plurality of second biometric information.

22. The person verification method according to item 21, wherein in the threshold value determining step, when there is a second biometric information in the plurality of second biometric information from which appropriate threshold value can not be determined, determine to delete the second biometric information.

23. The person verification method according to item 22, wherein the storage section stores candidates for second biometric information, and further comprising:

registering the candidates for second biometric information as new second biometric information when said threshold determining section determines to delete.

24. The person verification method according to item 14, wherein the first biometric information and the second biometric information are based on facial images.

In the present invention, during person verification using biometric information, by retaining the history of past verification judgment as verification information, determining, based on this verification information, at the time of each verification judgment, the judgment threshold value that becomes the reference for judgment, and by updating the verification information, it is possible to set the judgment threshold value appropriate for the respective biometric information. Because of this, it is possible to provide a person verification apparatus and a person verification method that improves the accuracy of verification judgment in person verification, and can maintain a sufficiently high correct person acceptance rate and sufficiently high wrong person rejection rate.

### BRIEF DESCRIPTION OF THE DRAWINGS

FIG. 1 is a block diagram representing an example of the configuration of a person verification apparatus according to the present preferred embodiment of the present invention.

FIG. 2 is a diagram representing an example of the data contents stored in the storage section 14 of FIG. 1.

FIG. 3 is a flow chart representing the flow of registration processing in the person verification apparatus 1 of FIG. 1.

FIG. 4 is a diagram representing qualitatively the manner in which the correct person acceptance rate and the wrong person rejection rate change with respect to the changes in the judgment threshold value during person verification judgment.

FIG. 5 is a flow chart representing the flow of verification processing in the person verification apparatus 1 of FIG. 1.

FIG. 6 is a diagram representing an example of the position of facial features part for extracting the feature quantity from a facial image.

FIG. 7 is a flow chart representing the flow of the judgment threshold value determining processing in person verification.

FIG. 8(a) is a diagram representing an example of the feature space in which the facial features quantity as the biometric information is expressed as a partial space compressed to two dimensions.

FIG. 8(b) is an enlarged view diagram of FIG. 8(a) representing the position of each feature quantity and the range of initial setting judgment threshold values.

FIG. 9(a) is, during verification judgment of a person A, an enlarged view of the feature space representing the condition in which the judgment threshold value has been corrected downward.

FIG. 9(b) is a diagram of the feature space representing the overall condition in the state in which the judgment threshold value of person A has been corrected downward.

FIG. 10 is a flow chart representing the flow of registered data updating processing during person verification.

FIG. 11 is a flow chart representing the flow of a verification processing different from that of FIG. 5 during person verification.

### DETAILED DESCRIPTION OF THE PREFERRED EMBODIMENTS

Some preferred embodiments of the present invention are explained below referring to the drawings.

Configuration of Person Verification Apparatus:

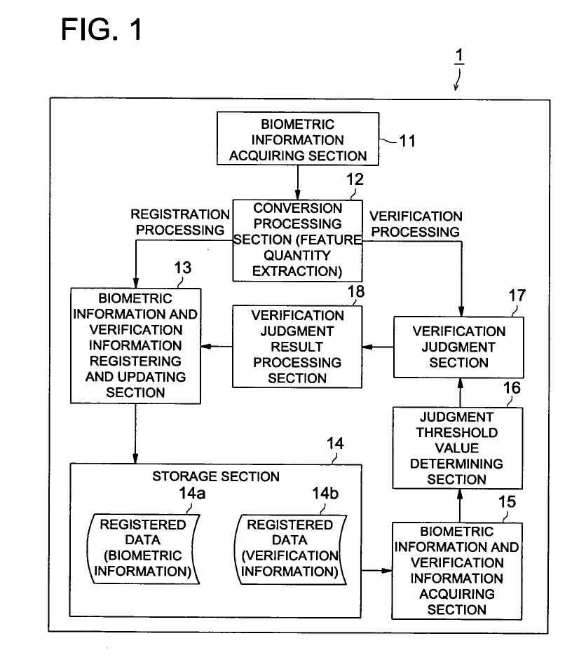

FIG. 1 represents a configuration of a person verification apparatus according to the present preferred embodiment of the present invention. An example of the overall configuration of a person verification apparatus 1 is explained here using FIG. 1.

In figure, the person verification apparatus 1 is made up of the following constituent elements.

11 is the biometric information acquiring section that acquires biometric information from the person who is the target for carrying out person verification. In other words, this functions as the first biometric information acquiring section.

As the biometric information, biometric information unique to a person such as finger prints, face, iris, hand geometry, etc., with which it is possible to verify a person and with which it is not possible in principle for some other person to impersonate the correct person, are used. The image information is taken into the apparatus, for example, by the person pressing a finger or hand on the finger print or hand geometry collection surface of the apparatus in the case of finger prints or hand geometry, or by detecting the target and photographing using a camera in the case of face or iris. In the present preferred embodiment, it is assumed that a facial image is obtained as the biometric information.

12 is the conversion processing section and carries out conversion processing of the biometric information acquired in the biometric information acquiring section 11. With the intention of converting to an appropriate data format for carrying out verification judgment, in general, from the biometric information that has just been acquired, for example from facial image in the present preferred embodiment, feature quantities are obtained and retained as feature quantity data. Regarding the feature quantities and the method of their calculation, and also regarding the processing of dimension compression, etc., various publicly known technologies can be used. An actual example will be described later.

13 is the biometric information and verification information registering and updating section which registers, in the storage section 14 to be described later, the biometric information acquired by the biometric information acquiring section 11 along with the verification information. Or else, it updates, for biometric information that has already been registered, the verification information based on the result of verification to be described later. Therefore, the biometric information and verification information registering and updating section 13 functions as the biometric information registering and updating section and as verification information registering and updating section.

When registering newly the acquired biometric information, since there is no verification history, the verification information that is to be recorded while establishing correspondence with it is set to a prescribed initial condition. For example, a setting such as number of verification trials (0), number of verification successes (0), and judgment threshold value (prescribed initial value) is made. When updating the verification information for biometric information that has already been registered, the value set above is updated. For example, the setting is made as number of verification trials (1), number of verification successes (1), and judgment threshold value (prescribed initial value, and corrected value).

14 is the storage section, and stores the registered data (biometric data) 14a and the registered data (verification information) 14b registered by the biometric information and verification information registering and updating section 13. In other words, the storage section 14 functions as a storage means.

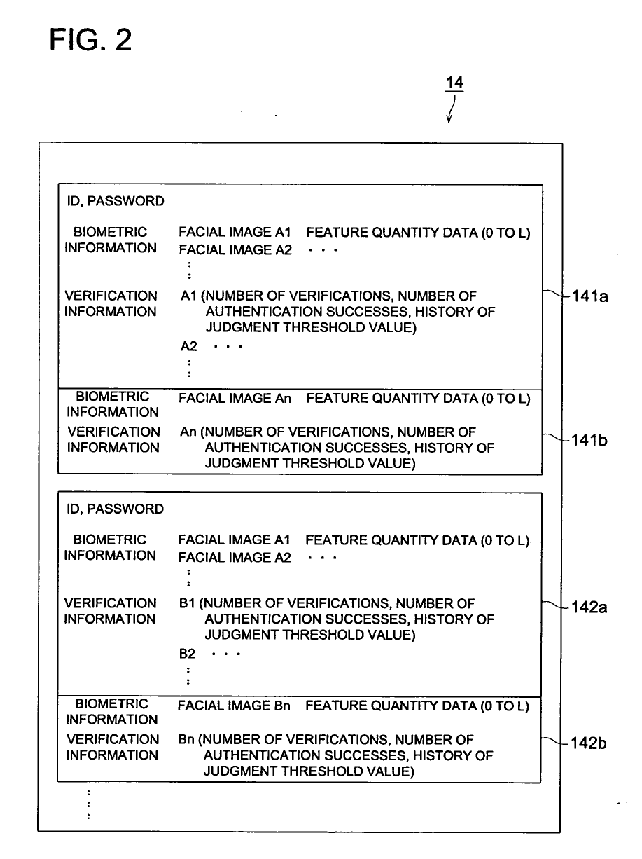

The content of the registered data stored in the storage section 14 is explained using FIG. 2. In FIG. 2, an example of the state in which a plurality of biometric information and a plurality of verification information corresponding respectively to them have been recorded.

The items stored in the storage section 14 in FIG. 2 are, the registered data 141a and the registered data candidate 141b for person A, also the registered data 142a and the registered data candidate 142b for person B, and also, in a similar manner, it is possible to record the registered data and the registered data candidate for any arbitrary plural number of persons from person C onwards. However, the registered data candidate need not be present also.

In the registered data 141a for the person A, apart from the data used for verification such as the ID, password, etc., biometric information and verification information are stored, as biometric information are stored a plurality of facial images (A1, A2, . . . ) and the feature quantity data for each of them, and as verification information are stored the information related to the verification history corresponding to each of those plurality of facial images, as has been shown in FIG. 2. The registered data 142a for person B and the registered data for person C and onwards are also similar. The stored contents of the registered data candidates (141b, 142b, . . . ) for each person are also similar.

Although verification operations are also made for the registered data candidates in a manner similar to the registered data and the results are updated and stored as the verification information, they are not used for the actual verification judgment. Although described later, the verification information of the registered data candidates are referred to at the time of registering them newly as registered data.

Returning to FIG. 1, the explanation of the configuration of the person verification apparatus 1 is continued below.

15 is the biometric information and verification information acquiring section which accesses the storage section 14 and acquires the registered data (biometric information and verification information) related to a specific person (for example, person A). In other words, it functions as the second biometric information acquiring section.

At this time, it is also possible to select the particular person, whose registered data is to be acquired, using data for person authentication such as ID, password, etc. In that case, the registered data (biometric information) having the same ID or password as the first biometric information acquired newly by the biometric information acquiring section 11 is acquired as the second biometric information by the biometric information and verification information acquiring section 15, and the verification judgment is made by comparing it with the first biometric information.

16 is the judgment threshold value determining section. The judgment threshold value used in verification judgment using biometric information is determined based on the corresponding verification information. In other words, this functions as a judgment threshold value determining means.

In the present preferred embodiment, the judgment threshold value used in verification judgment can also be different for each different person for whom person verification is being made, and can also vary each time the person verification is being made. The judgment threshold value determining section 16 has the function of determining the judgment threshold value based on the verification information at each time that a person verification is made, and the result of that is updated and recorded as a verification information. Therefore, further, based on that updated verification information (including the history of the judgment threshold value), the judgment threshold value used at the time the next verification judgment is determined.

The details of the method of determining the judgment threshold value by the judgment threshold value determining section 16 are explained later.

17 is the verification judgment section, and carries out the verification judgment of whether or not the above first biometric information and the second biometric information are of the same person, based on the judgment threshold value determined by the judgment threshold value determining section 16 as described above. In other words, this functions as a verification judgment means.

The method of verification judgment is one in which the degree of similarity is computed from the feature quantity data of the above first biometric information and the second biometric information respectively, and the judgment is made by comparing it with the judgment threshold value. When compared with the judgment threshold value, the verification becomes successful if the degree of similarity is high, that is, the person is authenticated as the correct person, and the verification fails if the degree of similarity is low, that is, the person is not the correct person. Even regarding this, the details of judgment are described later.

18 is the verification judgment result processing section that determines the handling of the registered data based on the result of verification judgment by the verification judgment section 17. For example, the content to be updated in the verification information due to the result of verification judgment is instructed to the biometric information and verification information registering and updating section 13, and carries out the updating of the registered data (verification information) in the storage section 14.

Further, the verification judgment result processing section 18 may also instruct the biometric information and verification information registering and updating section 13 to delete a registered data (biometric information) or to register newly a registered data candidate. Even regarding this, the details are explained later.

Operation of the Person Verification Apparatus: Next, the operation of the person verification apparatus 1 is explained below.

There are mainly two flows in the operation of the person verification apparatus 1. One is the flow of the registration processing of registering the biometric information for each person, in which the registered data for person verification is stored in the storage section 14 inside the person verification apparatus 1. The other is the flow of the verification processing of verifying whether or not the person is the correct person for each person by comparing the biometric information acquired newly with the registered data. Therefore, the registration processing is the preparation for the verification processing and is carried out in advance.

In FIG. 1, the difference between the case of carrying out registration processing of the biometric information acquired from each person and the case of carrying out verification processing is indicated by two arrows coming out of the conversion processing section. In the case of registration processing, the processing ends after the biometric information is stored in the storage section 14 by the biometric information and verification information registering and updating section 13. In the case of verification processing, the biometric information is compared and judged by the verification judgment section 17 with the registered data acquired from the storage section 14. Depending on the result of judgment, the processing of updating the verification information, etc., is done by the verification judgment result processing section 18 and the processing ends.

The flows of the registration processing and the verification processing are explained below referring to the drawings.

Flow of Registration Processing:

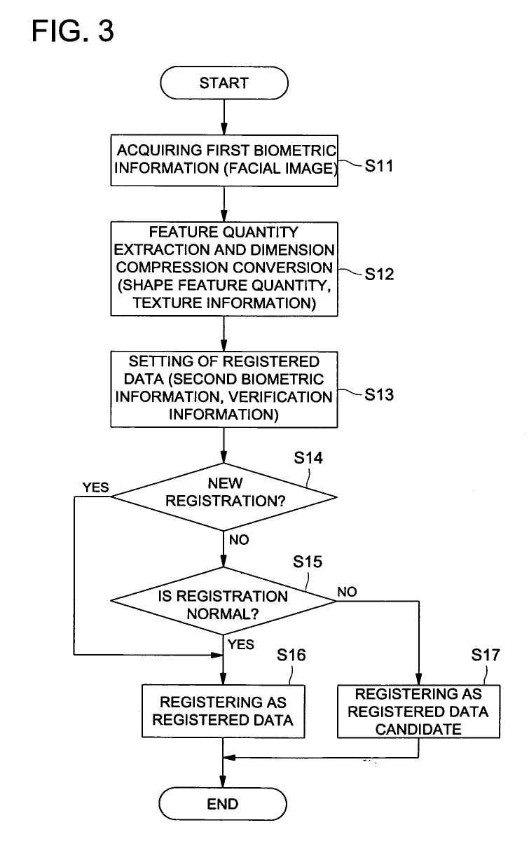

FIG. 3 is a flow chart representing the flow of registration processing in the person verification apparatus 1. The flow of registration process is explained below by using FIG. 3. In addition, FIG. 1 too is referred to at appropriate times.

When the registration processing is started, to begin with in Step S11, the face information of a particular person is acquired as the first biometric information by the biometric information acquiring section 11.

For example, the face of a particular person A is photographed by an image inputting apparatus such as a camera, etc., and that facial image is acquired by the biometric information acquiring section 11 of the person verification apparatus 1. The image inputting apparatus can be either a constituent element of the biometric information acquiring section 11, or installed separately so that the image input can be made to the biometric information acquiring section 11 via a communication means, etc.

It is desirable that the facial image of person A is acquired a plural number of times, and that a plural number of facial images are registered as biometric information. It is desirable to carry out even verification judgment based on a plurality of biometric information in order to increase the accuracy of verification. In addition, apart from the plural number of biometric information (registered data) used for verification judgment, it is desirable to acquire biometric information as reserve registered data candidates and to retain them along with the registered data.

Next, in Step S12, the processing of feature quantity extraction and dimension compression conversion are made by the conversion processing section 12 for the acquired facial images. The purpose is to make the data form appropriate for carrying out verification judgment processing, and is to express the degree of similarity between biometric data as distance in the feature space. While various publicly known technologies can be used for the extraction of the feature quantity data, one concrete example of these is described later.

In Step S13, the registered data is set by the biometric information and verification information registering and updating section 13. The registered data has the contents as has been explained in FIG. 2, and for example, the biometric information acquired from person A (feature quantity data calculated from the facial images and subjected to conversion processing), verification information (the number of verification trials, number of verification successes, history of judgment threshold value, etc., set in the initial condition), and authentication data such as ID, password, etc. are set.

Next, in Step S14, a judgment is made as to whether the registration of the registered data set in Step S13 is a new registration or not. In other words, this is the judgment of whether the biometric information of that person A has already been registered or not. If it is judged to be a new registration (YES in Step S14), the execution of Step S15 is omitted, and Step S16 is executed. If it is judged not to be a new registration (NO in Step S14), Step S15 is executed.

In Step S15, since the biometric information of person A has already been registered, a judgment is made as to whether or not the registration this time is a proper registration or not. In other words, the judgment is whether to make it as a registered data or to make it a registered data candidate. This can be set automatically from the number of biometric information already registered, etc., or a specification can be made each time.

If the judgment in Step S15 is that it is a proper registered data (YES in Step S15), Step S16 is executed. If the judgment is that it is not a proper registered data (NO in Step S15), Step S17 is executed.

In Step S16, the registered data set in Step S13 is registered and recorded as proper registered data in the storage section 14. Further, in Step S17, similarly, the registered data is registered and recorded as registered data candidate in the storage section 14 while establishing correspondence with proper registered data. These registration conditions are as already shown in FIG. 2.

The above process from Step S13 to Step S16 or to Step S17 is executed by the biometric information and verification information registering and updating section 13, and the registration processing ends when the recording in the storage section 14 is completed. When a plurality of facial images is to be registered as biometric information, the above registration processing is repeated each time.

Accuracy of Verification Judgment:

Next, before explaining the flow of the verification processing, the accuracy of the verification judgment is discussed below.

As has been described above, the verification of person A is that of comparing the first biometric information acquired from person A (or from another person impersonating person A) with the second biometric information of person A that has already been registered, and judging whether it is the correct person or not.

For the judgment, the degree of similarity between the first biometric information and the second biometric information is computed, and is compared with the judgment threshold value.

The following four types of possibilities are present in the result of judgment. (1) Person A is judged to be person A (the correct person). (2) Another person is judged to be not person A (wrong person). (3) Person A is judged to be not person A (wrong person). (4) Another person is judged to be person A (correct person).

Although there is no problem with the judgment results (1) and (2), the judgment results (3) and (4) are wrong, and the accuracy of judgment is better as the possibility of this type of judgments occurring becomes lower, and the accuracy becomes poor if the possibility of this type of judgments occurring is high.

The rate at which the judgment result (1) comes instead of the result (3) for person A is called the correct person acceptance rate. It is desirable that the correct person acceptance rate is as high, and 100% is ideal.

Further, the rate at which the judgment result (2) comes instead of the result (4) for a person other than person A is called the wrong person rejection rate. It is desirable that the wrong person rejection rate is as high, and 100% is ideal.

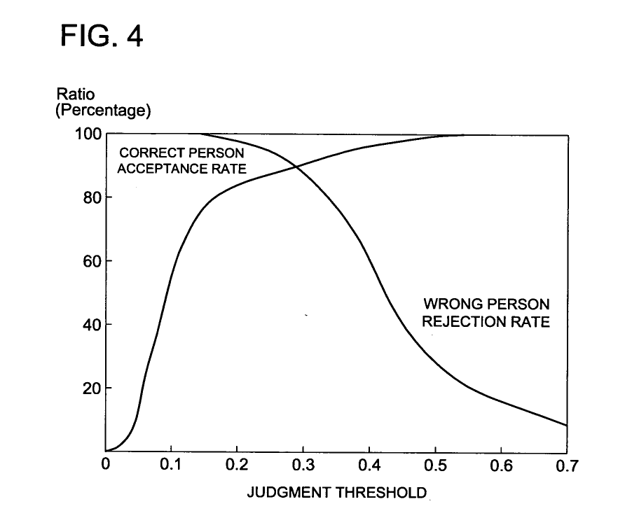

The correct person acceptance rate and the wrong person rejection rate in the verification judgment result vary respectively with the judgment threshold value used for comparing with the degree of similarity during the verification judgment. FIG. 4 shows qualitatively the manner in which the correct person acceptance rate and the wrong person rejection rate change with respect the changes in the judgment threshold value during person verification judgment.

In FIG. 4, as the threshold value becomes smaller the wrong person rejection rate becomes higher, which is desirable, however, on the other hand, the correct person acceptance rate becomes smaller. As the threshold value becomes larger the correct person acceptance rate becomes higher, however, on the contrary, the wrong person rejection rate becomes smaller. Therefore, from the point of view of the magnitude of the judgment threshold value, the correct person acceptance rate and the wrong person rejection rate have a tendency to oppose each other.

These relationships are affected by individual differences such as what kind of biometric information each person has and the variations in the registered data that has been registered for that person. Therefore, in order to increase the accuracy of verification judgment (making large both the correct person acceptance rate and the wrong person rejection rate), the following measures can be though of. (a) Adjusting the judgment threshold value so that the correct person acceptance rate and the wrong person rejection rate become appropriate. (b) Changing the judgment threshold value depending on the characteristics of the biometric information of each person. (c) Suppressing the variations in the registered data of each person (making the data close to the average of the variations).

The methods (a) and (b) are the operations of not only changing the judgment threshold value depending on each person, but also adjusting depending on the manner in which the correct person acceptance rate and the wrong person rejection rate appear. In the present preferred embodiment, as is described later, the processing is that of determining the judgment threshold value based on the verification information that expresses the past verification results.

Further, for the method (c), when it is not satisfactory by merely adjusting the judgment threshold value, it is desirable to replace the registered data itself that is used for the verification judgment. In the present preferred embodiment, registered data candidates are prepared, and the processing is carried out by taking the registered data candidate as the registered data, depending on the history of the result of verification judgment.

With the above points as the presumption, the flow of verification processing is explained below.

Verification Processing Flow 1:

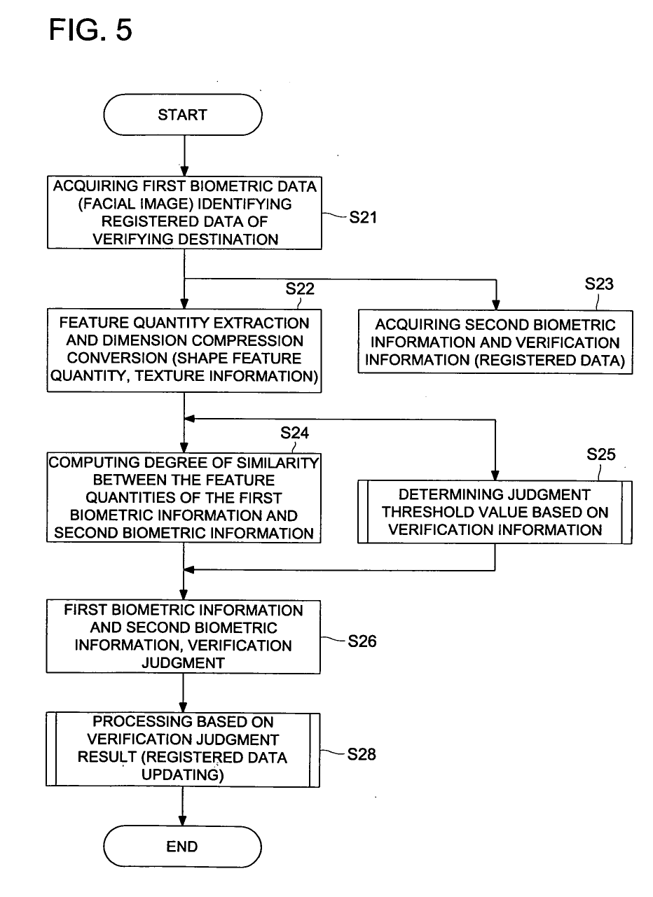

FIG. 5 is a flow chart representing the flow of verification processing in the person verification apparatus 1. Using FIG. 5, one example of the flow of verification processing is explained below. Also, FIG. 1 is referred to at appropriate times.

When the verification processing is started, to begin with in Step S21, the face information of a particular person is acquired as the first biometric information by the biometric information acquiring section 11. Therefore, Step S21 functions as a first biometric information acquiring process.

The method of acquiring face information as the biometric information is similar to that in the case of registration processing described regarding FIG. 3 above.

Next, in Step S22, the processing of feature quantity extraction and dimension compression conversion are made by the conversion processing section 12 for the acquired facial images. This also is similar to that in the case of registration processing described regarding FIG. 3 above.

The purpose is to make the data form appropriate for carrying out verification judgment processing, and is to express the degree of similarity between biometric data as distance in the feature space. A concrete example is described below when using facial images as the biometric information.

Example of Feature Quantity Extraction of Facial Images and Dimension Compression Conversion:

From the facial region, the positions (coordinates in the facial image) of the characteristic parts of the face are computed.

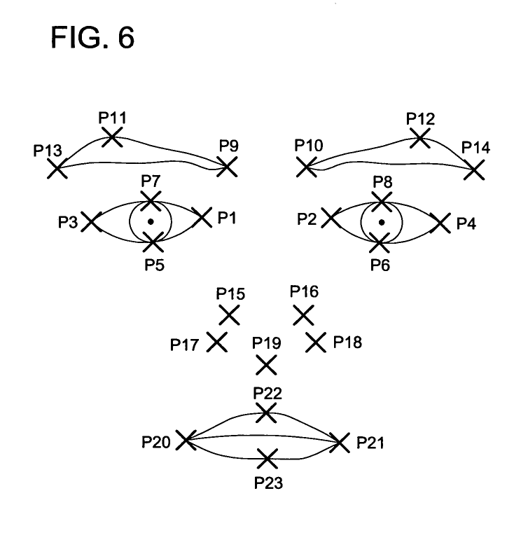

The characteristic parts of the face can be the parts such as the eyes (center of the pupil, inner corner of the eyes, outer corner of the eyes, top and bottom of the pupil), eyebrows (both ends and center), nose (end of the nose tip, bottom center, nostrils), position of the apex of the lower jaw, etc. FIG. 6 shows an example of the different parts whose positions are obtained in a facial image. For example, the points P1 to P23 in FIG. 6 are the facial feature parts that are to be obtained, and the positions of these points are computed.

The feature quantities used for face authentication are extracted from the facial image and the positions of its different characteristic parts. As the feature quantities, shape feature quantity and texture information are extracted.

The shape feature quantities, for example, can be extracted from the mutual relationship of the positions of the characteristic parts of the face. Since many relationship elements can be present, the shape feature quantity is expressed as a vector in a high-dimensional space. In addition, regarding texture information, it is possible to select a characteristic local area, and to use the density distribution in that area, that is, a two-dimensional pattern, after converting into a vector. Even this is a high-dimensional feature quantity, and in addition, if a plurality of characteristic local areas is selected, it results in a plurality of feature quantity vectors.

In general, dimension compression processing is carried out for these high-dimensional feature quantities.

For example, for a feature quantity x, sample data is collected experimentally, and the effective coordinate axis for dimension compression is obtain. The new feature quantity c in the new space is expressed by the following Equation (1).
x=xₘ+Pc (1)

Where xₘ is the average of the feature quantity x and P is the normal mode of the change (set of characteristic vectors).

A new space effective for dimension compression is set by P. ‘c’ is the feature quantity expressed in that space. The space expressed by P, with the thinking indicated below, can be considered to have already been reduced from n dimensions to k dimensions.

Regarding the fluctuations in the feature quantity x, it is considered to divide them into a partial space expressing individuality, and a partial space expressing fluctuations in the attributes. The conversion of reducing the feature quantity x from n dimensions to k dimensions (feature vector d) by dividing the feature space in this manner, can be expressed by Equation (2) using a matrix A as shown below.
d=A^{t}x (2)

Here, A is an n x k matrix. As the methods for determining the conversion matrix A, the methods indicated below are publicly known. (1) The partial space expressing individuality is obtained by selecting k of the main components having a large ratio (F ratio) of the intra-class dispersion to inter-class dispersion from the different types of components of the feature space (PCA Method). (2) Obtaining a projective space from the feature space so that the difference between the intra-class dispersion and the inter-class dispersion is large (EM Method). (3) Obtaining a projective space from the feature space so that the ratio of the intra-class dispersion to inter-class dispersion becomes large. This is the multiple discrimination analysis (MDA) method which is the Fisher's discrimination analysis method that is generalized to the multiple class problem.

The inter-class dispersion is a dispersion in the partial space expressing the individuality, and the intra-class dispersion is a dispersion in the partial space expressing the fluctuations in the attributes.

The combination of the shape feature quantity d^{s} and the local texture feature quantity d^{(k)} obtained by carrying out conversion processing as described above on the above shape feature quantity and texture information is either registered in the person verification dictionary or is used for computing the degree of similarity as the following facial feature quantities.

Facial feature quantities: (d⁽⁰⁾, d⁽¹⁾, . . . d^{(L)}), Where L is the number of local features and d⁽⁰⁾ is d^{s}.

Of course, the extraction of feature quantities for person verification can also be done with shape feature quantities and texture information independently.

Returning to FIG. 5, the next step of verification processing is explained below.

In Step S23, the registered data (biometric information and verification information) is acquired from the storage section 14 by the biometric information and verification information acquiring section 15. Therefore, Step S23 functions as a second biometric information acquiring process.

If the person whose first biometric information was acquired in Step S21 has presented the ID or password as person A, the second biometric information and verification information regarding person A for verification judgment is acquired from the storage section 14 using that ID or password, etc. The second biometric information would have already been stored in the storage section 14 as feature quantity data.

When Step S22 and Step S23 are completed, the next steps Step S24 and Step S25 are executed.

In Step S24, using the feature quantity data of the above first biometric information and the second biometric information, the degree of similarity between the two are computed by the verification judgment section 17. A concrete example of computing the degree of similarity for the facial feature quantities explained in Step S22 is explained below.

Computation of Degree of Similarity:

The degree of similarity is computed between the facial feature quantity extracted after acquiring the first biometric information (hereinafter referred to as the first facial feature quantity) and the facial feature quantity acquired as the second biometric information from the registered data (hereinafter referred to as the second feature quantity).

The degree of similarity of the shape feature quantity is the sum of the Euclidean distances between the different vertices indicating the positions of the characteristic parts of the face in the first and the second facial feature quantities, and can be computed as in Equation (3) given below.
D^{s}ᵢⱼ=(d^{s}ⱼ−d^{s}ᵢ)^{t}(d^{s}ⱼ−d^{s}ᵢ) (3)

Here, i and j are variables indicating the first and the second facial feature quantities, respectively.

The local texture feature quantity is taken to be only the number L of the local features.

The degree of similarity for each local texture feature quantity is computed as per the following Equation (4) using the distances (for example, Euclidean distances) of the various local texture feature quantities k (k=1 . . . L) in the first and the second facial feature quantities in the respective feature spaces.
D^{(k)}ᵢⱼ=(dⱼ−dᵢ)^{t}(dⱼ−dᵢ) (4)

The computation of the degree of similarity is carried out for each group of facial feature quantities, and the overall degree of similarity is computed according to the following Equation (5) by the weighted sum of the degrees of similarities of each group of facial feature quantities.
Dᵢⱼ=W^{s}D^{s}+ΣWₖD^{(k)}ᵢⱼ (5)

Here, Σ signifies the overall sum for all values of k (k=1 . . . L).

Further, as another method of computing the degree of similarity, it is also possible to express the degree of similarity between the sample i and the sample j of the respective first and second facial feature quantities as a Mahalanobis distance in the k-dimensional partial space. In that case, the degree of similarity can be computed according to the following Equation (6).
Dᵢⱼ=(dⱼ−dᵢ)^{t}S^{d}ₘ⁻¹(dⱼ−dᵢ) (6)

Here, Sₘ is the co-dispersion matrix and is computed according to the following Equation (7).
S^{d}ₘ=(1/M)ΣΣ(d_{fm}−d_{c})(d_{fm}−d_{c})^{t} (7)

Here, ΣΣ is the overall sum for f and m. Also, f is the variable expressing each person, m is a variable expressing each sample for each person, and M is the total number of samples, that is, the product of the total number of f and the total number of m. Also, d_{c} is the average of all values of d_{c} for f and m, and is calculated according to the following Equation (8).
d_{c}=(1/M)ΣΣd_{fm} (8)

Here, ΣΣ is again the overall sum for f and m.

In the above manner, the degree of similarity between the first facial feature quantity and the second facial feature quantity is expressed by the distance between the two in the features space, and the degree of similarity becomes high when the distance is short and becomes low when the distance is large.

In Step S25, based on the verification information acquired in Step S23, the judgment threshold value to be used for the next verification judgment is determined by the judgment threshold value determining section 16. Therefore, Step S25 functions as the judgment threshold value determining process.

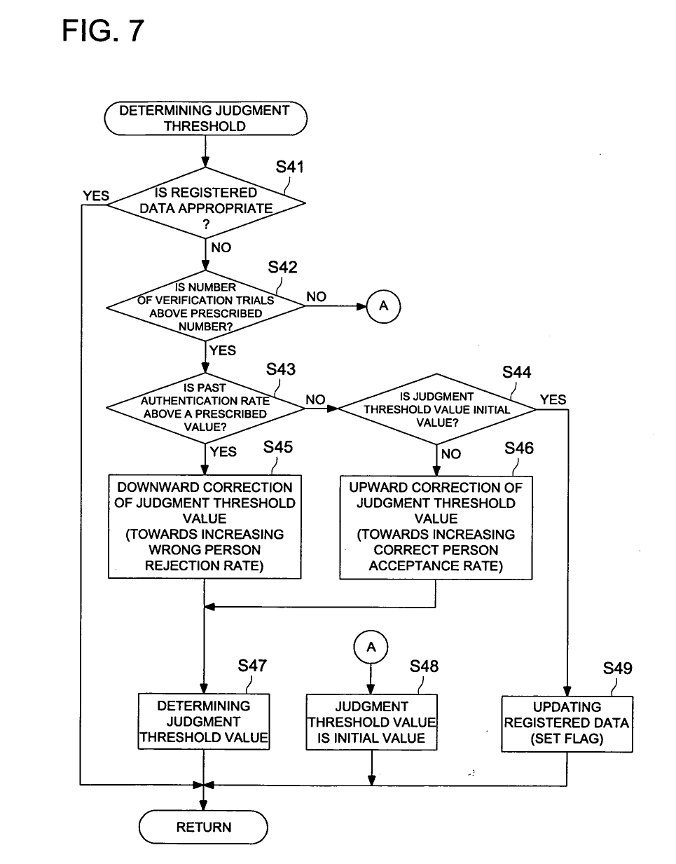

The determination of the judgment threshold value in Step S25, as has already been explained regarding the accuracy of verification judgment, has a large effect on the next verification judgment, and also on the updating processing of the registration data based on the result of verification judgment. The determination of the judgment threshold value in Step S25 is explained in detail later referring to FIG. 7.

In Step S26, verification judgment is carried out by the verification judgment section 17 by comparing the degree of similarity between the first and the second facial feature quantities computed in Step S24 with the judgment threshold value determined in Step S25. In other words, a judgment is made as to whether or not the target person for whom the first facial features quantity was acquired is the person A for whom the second facial features quantity has been registered. Therefore, the above steps Step S24 and Step S25 function as a verification judgment process.

When a plurality of the second biometric information (second facial feature quantities) for person A acquired from the storage section 14 are present, the verification operation with the first biometric information is carried out for each biometric information, and if at least one results in authentication as the correct person, the overall judgment that it is person A is made. It is desirable that the judgment result obtained for each biometric information is used for judging whether that individual biometric information is appropriate to be a registered data.

In Step S28, based on the verification judgment result in Step S26, the updating processing of the registered data (biometric information, verification information.) is carried out. Therefore, Step S28 functions as the biometric information registering and updating process and the verification information registering and updating process.

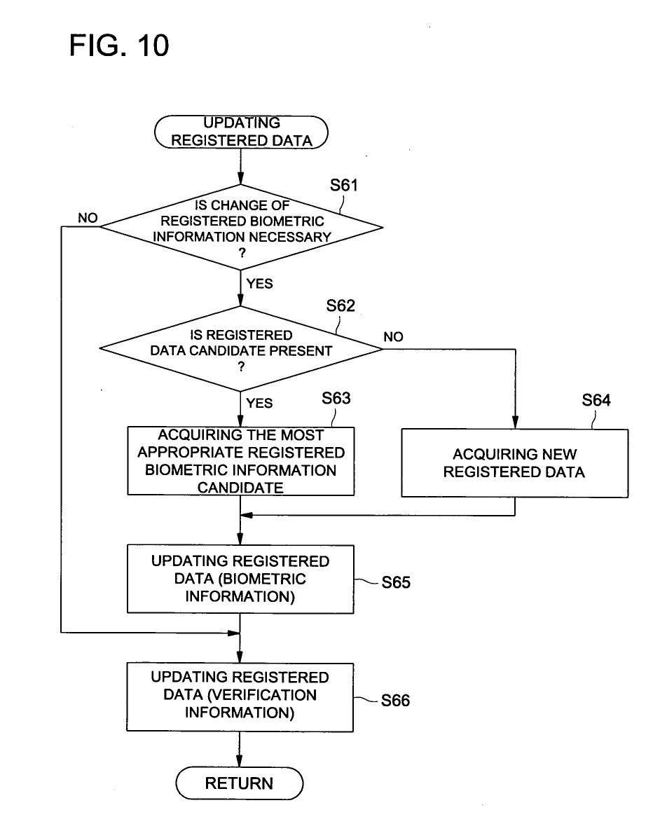

In the registered data updating processing in Step S28, although the verification information (number of verification trials, number of verification successes, and the history of judgment threshold value, etc.,) is updated, in some cases, updating of the biometric information (deleting registered data, registration of registered data candidate, etc.,) is also made. The processing of the updating of the registered data (biometric information, verification information) is explained in detail later referring to FIG. 10.

When the registered data updating processing is completed in Step S28 a preparation for the next verification, the person verification processing ends.

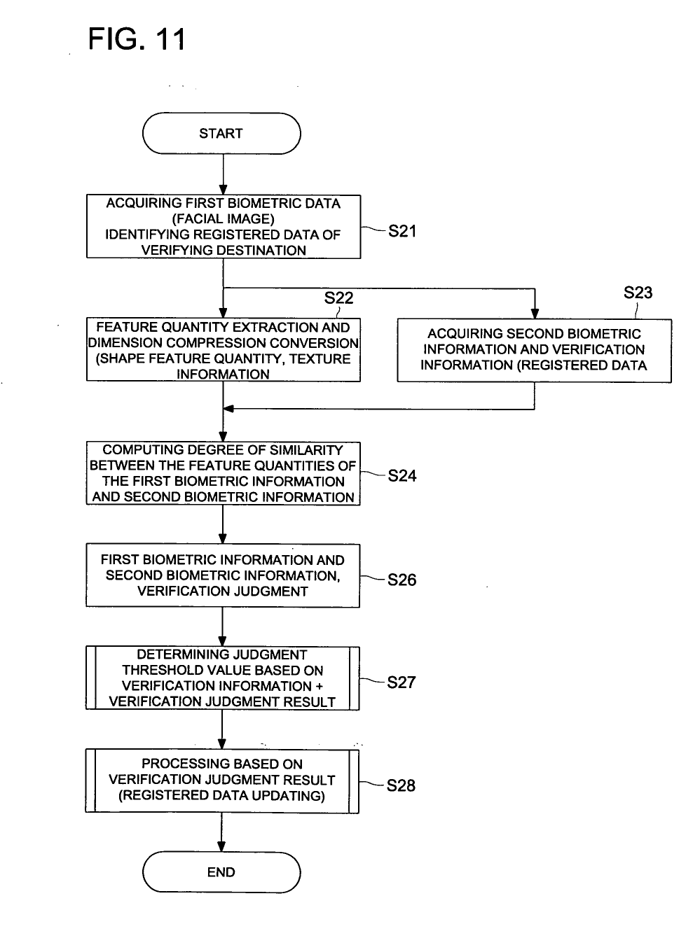

However, regarding the determination of the judgment threshold value carried out in Step S25, although the procedure was that of carrying it out before the verification judgment, in order to use it for verification judgment, it is also possible to carry out the determination of the judgment threshold value at any time. Even an example of the procedure of updating the judgment threshold value after verification judgment for the next verification judgment is explained later using FIG. 11.

Determining the Judgment Threshold Value:

FIG. 7 is a flow chart representing the flow of determining the judgment threshold value. Using FIG. 7, the procedure of the judgment threshold value determining processing in Step S25 in FIG. 5 is explained here.

To begin with, in Step S41, a judgment is made as to whether or not the registered data is appropriate. This is intended for judging whether or not to carry out the following processing of determining the judgment threshold value, and is carried out by making the following operations.

When the registered data is appropriate, that is, if it can be taken that the fluctuations due to corrections in the judgment threshold value are already tending to converge (YES in Step S41), such as, for example, if the fluctuations in the judgment threshold value during the past for a specific period of time are less than a specific value referring to the verification information (history of the judgment threshold value), the registered data is judged to be appropriate, and no processing of determining the judgment threshold value is made. In other words, the judgment threshold value remains the same, and the processing of determining the judgment threshold value is ended.

When the registered data is not appropriate, that is, if it can be taken that the fluctuations due to corrections in the judgment threshold value are large (NO in Step S41), such as, for example, if the fluctuations in the judgment threshold value during the past for a specific period of time are more than a specific value referring to the verification information (history of the judgment threshold value), the registered data is judged to be not appropriate, and it being necessary to carry out the processing of determining the judgment threshold value, the Step S42 is executed next.

In Step S42, a judgment is made as to whether or not the number of verification trials is more than a specific number of trials. The intention of this is, when the number of verification trials is still not sufficient, to take it insufficient to modify the judgment threshold value based on its history, and to use the initial value as it is without carrying out the following judgment threshold value updating processing.

When the history is sufficient, for example, referring to the verification information (number of verification trials), if it is more than a prescribed number of trials (YES in Step S42), since it is necessary to carry out the processing of determining the judgment threshold value, the Step S43 is executed next.

When the history is not sufficient, for example, referring to the verification information (number of verification trials), if it is less than a prescribed number of trials (NO in Step S42), it is judged that the history is insufficient and the Step S48 is executed next. In Step 48, the judgment threshold value is determined to be the initial value as it is, and the processing of determining the judgment threshold value is ended.

In Step S43, a judgment is made as to whether the correct person acceptance rate in the past is above a specific value or not. The intension of this judgment is to decide on changing the judgment threshold value so as to adjust it, since it implies that the balance between the correct person acceptance rate and the wrong person rejection rate is disturbed when the authentication rate in the past history is high or low when compared to a prescribed value.

When the authentication rate in the past is above a prescribed value (YES in Step S43), the Step S45 is executed. When the authentication rate in the past is below a prescribed value (NO in Step S43), the Step S44 is executed.

In Step S45, since it is a situation in which the correct person recognition rate is high but at the same time the wrong person rejection rate has become low, a correction is made in the direction of increasing the wrong person rejection rate, that is, in the direction of reducing the judgment threshold value. Next, in Step S47, the corrected judgment threshold value is determined, and the processing of determining the judgment threshold value is ended.

In Step S44, before correcting the judgment threshold value, a judgment is made as to whether or not the current judgment threshold value is in the initial state or not. The intension of this is that, because the maximum permissible judgment threshold value (that is, a judgment threshold value so that the wrong person rejection rate cannot be reduced any further) has been set as the initial value, to carry out whether or not it is possible to correct the judgment threshold value in the upward direction.

In other words, in Step S46, since the correct person acceptance rate is low, although it is necessary to correct the judgment threshold value in the direction of increasing the correct person acceptance rate, this on the other hand also reduces the wrong person rejection rate. If the judgment threshold value is the initial value, since it is not possible to reduce the wrong person rejection rate any more, the initial value is retained as such.

In Step S44, if the current judgment threshold value is found to be equal to the initial value (YES in Step S44), Step S49 is executed next. In Step S49, although no correction of the judgment threshold value is made (correction cannot be made because the wrong person rejection rate has to be maintained), the registered data itself is taken not to be appropriate (there is no balance between the correct person acceptance rate and wrong person rejection rate), and a flag is set requesting for modifying the registered data itself. This flag is reflected in the registered data updating processing based on the verification judgment result. In the condition in which the flag for modifying the registered data has been set, the processing of determining the judgment threshold value is ended.

In Step S44, if the current judgment threshold value is found to be not equal to the initial value (NO in Step S44), Step S46 is executed next. In other words, in Step S46, it is taken that it is possible still to reduce the wrong person rejection rate, and correction of the judgment threshold value is made in the direction of increasing the correct person acceptance rate, that is, in the direction of increasing the judgment threshold value. Next, in Step S47, the corrected judgment threshold value is determined, and the processing of determining the judgment threshold value is ended.

In this manner, the determination of the judgment threshold value is made while correcting it based on the past history of the judgment threshold value so that the judgment threshold value converges while a balance is achieved between the correct person acceptance rate and the wrong person rejection rate. Naturally, the presumption is that an optimal judgment threshold value exists, and that appropriate judgment threshold value differs for each individual person. Therefore, corrections are made in the above manner, and the value is converged while searching.

Correction of Judgment Threshold Value and Verification Judgment:

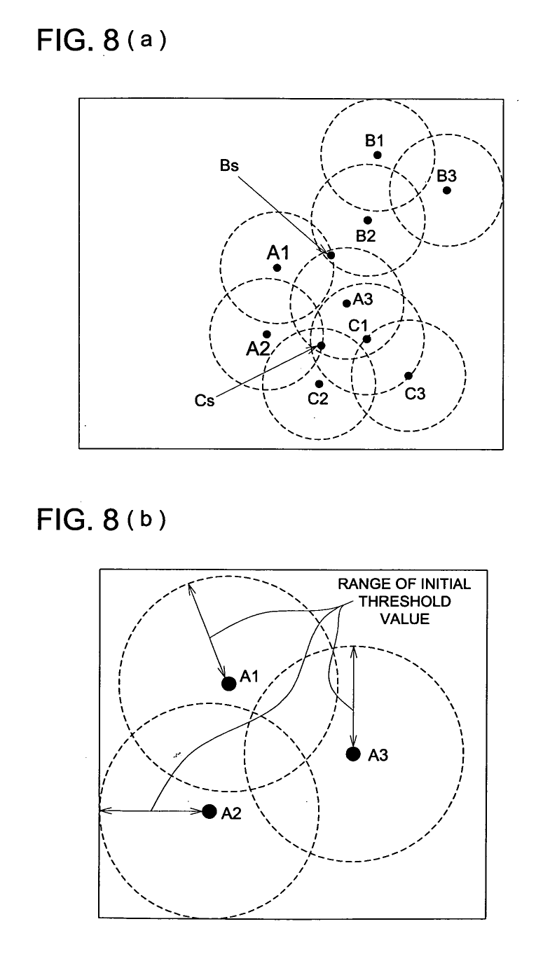

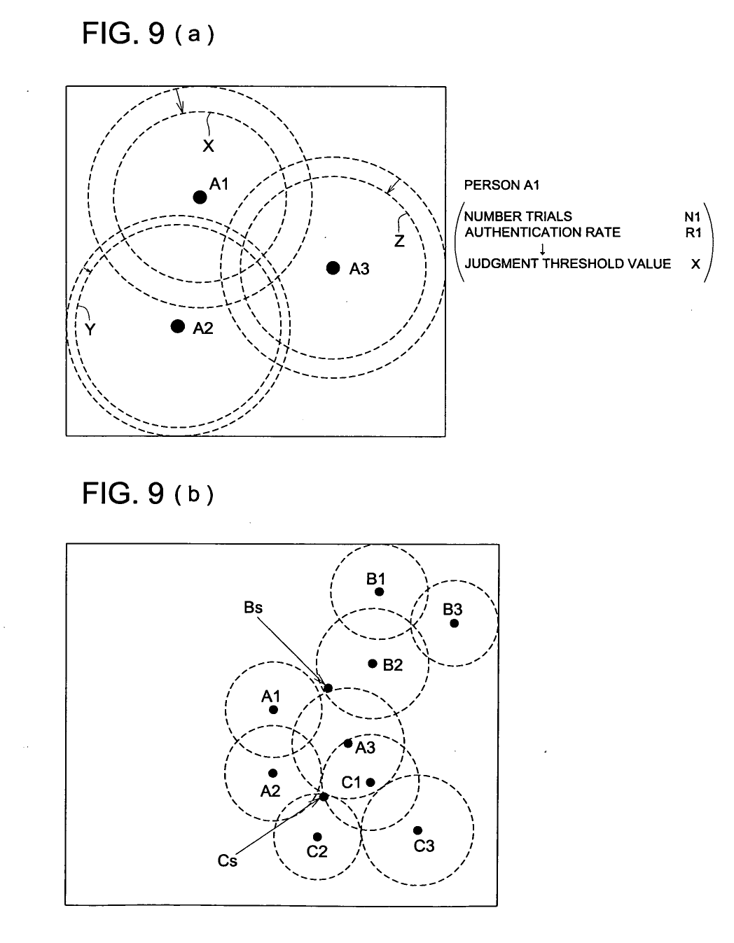

Using FIG. 8 and FIG. 9, the manner in which the judgment threshold value is corrected and the effect on the verification judgment is explained here.

FIG. 8(a) is a diagram of the feature space in which the facial features quantity as the biometric information is expressed as a partial space compressed to two dimensions. FIG. 8(b) is a diagram representing the position of each feature quantity and the range of initial settings of the judgment threshold value.

In FIG. 8(a), regarding three persons, namely, person A, person B, and person C, the registration data for three types of facial feature quantity data are shown for each person (for example, A1, A2, and A3 for person A). Further, not only the positions within the feature space are shown for each of them, but also the ranges of judgment threshold values set initially are shown by broken line circles with the positions of each feature quantities at the centers of the circles.

As the case of person A is shown enlarged in FIG. 8(b), the radius of the broken line circle corresponds to the judgment threshold value. In other words, if the feature quantity data of the person being verified is within the broken line circle, since the distance from the feature quantity of the registered person A (the degree of similarity) is within the judgment threshold value, the person being verified is authenticated as person A. If the feature quantity data of the person being verified is outside the broken line circle, since the distance from the feature quantity of the registered person A (the degree of similarity) exceeds the judgment threshold value, the person being verified is not person A, that is, the person being verified is not authenticated as person A.

In the case of FIG. 8(a), as the data for verification, the positions of the feature quantity data Bs to be verified with person B and of the feature quantity data Cs to be verified with person C have been shown. Although the feature quantity data Bs to be verified with person B is within the judgment threshold value of B2 and hence the person is authenticated as person B, but on the other hand, it is also within the judgment threshold values of A1 and A3, and hence if the person calls himself person A and is verified, he will be authenticated as person A. In other words, it is possible for this person to impersonate person A.

The same can also be said to be true about the feature quantity data Cs to be verified with person C. Although the feature quantity data Cs is within the judgment threshold values of C1 and C2 and the person is authenticated as person C, on the other hand, it is also within the judgment threshold values of A2 and A3, and hence if the person calls himself person A and is verified, he will be authenticated as person A. In other words, it is possible for this person to impersonate person A.

However, as in the present preferred embodiment, if the correction processing of the judgment threshold value based on the result of verification is repeated, this kind of problem gets gradually adjusted. For example, if the wrong person rejection rate decreases (the authentication rate increases) with respect to the past verification judgment result due to the above type of impersonation, the correction is made so as to increase the wrong person rejection rate, that is, in the direction of reducing the judgment threshold value.

In FIG. 9(a), an example of the judgment threshold value having been reduced is shown enlarged for the case of person A. This is an example in which, for the registered data Al, in accordance with the result of an authentication rate of R1% over the past N1 times of verification trials, the judgment threshold value has gone down to X, and even for the registered data A2 and A3, in a similar manner, the judgment threshold values have gone down to Y and Z.

If we see the effect of the decrease in the judgment threshold value by returning to the feature space diagram of FIG. 9(b), although the feature quantity data Bs to be verified with person B is within the judgment threshold value of B2 and hence the person is authenticated as person B, but on the other hand, it has fallen outside the judgment threshold values of A1 and A3, and hence even if the person calls himself person A and is verified, he will not be authenticated as person A. In other words, it is not possible for this person to impersonate person A.

Further, the same can also be said to be true about the feature quantity data Cs to be verified with person C. Although the feature quantity data Cs is within the judgment threshold values of C1 and C2 and the person is authenticated as person C, but, on the other hand, it has fallen outside the judgment threshold values of A2 and A3, and hence even if the person calls himself person A and is verified, he will not be authenticated as person A. In other words, it is not possible for this person to impersonate person A.

In the above, although the judgment threshold value is being determined using the authentication rate as the verification information, it is also possible to determine the judgment threshold value using the past history of the degree or similarity, or to determine the judgment threshold value using any past verification history. For example, if the judgment threshold value is to be determined using the past history of the degree or similarity, it is possible to prepare a table of computation parameters such as the average value of the degree of similarity, etc., and the judgment threshold value corresponding to it, and to refer to this table each time.

Updating the Registered Data:

FIG. 10 is a flow chart representing the flow of updating the registered data. In FIG. 10, the procedure of updating the registered data based on the verification judgment result in Step S28 of FIG. 5 is explained here.

To begin with, in Step S61, a judgment is made as to whether or not updating is necessary for the biometric information of the registered data. This is a judgment dependent on whether or not the registered data update flag has been set at the time of determining the judgment threshold value in Step S25 of FIG. 5, and the operations are made as follows.

If it is judged that the registration data update flag is set, that is, if it is judged that it is not sufficient merely to correct the judgment threshold value (YES in Step S61), it is judged that the registered data (biometric data) has to be updated, and the next Step S62 is executed. Otherwise, it means that it is sufficient to update only the verification information in the registered data, and the execution proceeds to the updating processing of the verification information in Step S66.

In Step S62, regarding the modification of the registered data (biometric information) based on the verification judgment result, a judgment is made as to whether or not a registered data candidate is present in the storage section 14. If registered data candidate is present (YES in Step S62), Step S63 is executed, and if registered data candidate is not present (NO in Step S62), the next Step S64 is executed.

In Step S63, the registered data candidate is acquired, and if a plurality of registered data candidates is present, the most appropriate registered data candidate is selected and acquired. Regarding which registered data candidate is the most appropriate, it is possible to decide by referring to the verification data of each registered data candidate, and comparing the past verification history. Therefore, for the registered data candidates, it is desirable that verification operation is made for them similar to the registered data even if they are used for judgment, and to record the update as the verification information.

In Step S64, there is no registered data candidate. The processing is of two types, that is, either no updating of the registered data is made, or new registered data candidate is obtained. When new registered data candidate is obtained, the registration processing that has already been described is necessary. When registration processing is possible immediately, after the registration processing is carried out, the next Step S65 is executed. If registration processing is not possible immediately, after that fact is displayed, etc., it will be possible to execute the next step.

In Step S65, the registered data for which the registered data update flag has been set is deleted from the storage section 14, and instead, the acquired registered data candidate is registered and recorded as the registered data in the storage section 14. If there is no appropriate registered data candidate and it is not possible to update, it is possible only to delete the registered data. However, when there is only one registered data, it is not appropriate to delete it, and it is desirable to retain it until a new registered data candidate can be obtained.

In Step S66, the updating of the verification information of the registered data is carried out. If updating of the registered data (biometric information) had been done in Step S65, since even this updating of verification information too would have been at that point of time, Step 65 and Step 66 are processed at the same time. If the registered data update flag has not been set in Step S61, among the registered data, only the verification information will be updated.

Verification Processing Flow 2:

As has already been explained, in the explanation of the verification processing of FIG. 5, the determination of the judgment threshold value made in Step S25 can be made at any time in the flow of the verification processing.

FIG. 11 is a flow chart representing the flow of a processing different from that of FIG. 5 in the verification processing of the person verification apparatus 1. In the following, referring to FIG. 11, an example of the procedure of updating the judgment threshold value for the next verification after verification judgment is explained below.

When the verification processing is started, first, in Step S21, the facial information of a particular person is acquired as the first biometric information from the biometric information acquiring section 11. Therefore, Step S21 functions as the first biometric information acquiring process. The method of acquiring the facial information as the biometric information is the same as that explained for FIG. 5.

In the next Step S22, the processing of feature quantity extraction and dimension compression conversion are made by the conversion processing section 12 for the acquired facial images. This also is similar to that explained for FIG. 5.

In Step S23, the registered data (biometric information and verification information) is acquired from the storage section 14 by the biometric information and verification information acquiring section 15. Therefore, Step S23 functions as a second biometric information acquiring process. This also is similar to that in the case of Step S23 explained for FIG. 5.

When Step S22 and Step S23 are completed, the next Step S24 and Step S25 are executed.

In Step S24, using the feature quantity data of the above first biometric information and the second biometric information, the degree of similarity between the two are computed by the verification judgment section 17. This also is similar to that in the case of Step S24 explained for FIG. 5.

In Step S26, verification judgment is carried out by the verification judgment section 17 by comparing the degree of similarity between the first and the second facial feature quantities computed in Step S24 with the judgment threshold value. In other words, a judgment is made as to whether or not the target person for whom the first facial features quantity was acquired is the person A for whom the second facial features quantity has been registered. Therefore, the above steps Step S24 and Step S26 function as a verification judgment process.

Here, the difference with Step S26 of FIG. 5 is that, the judgment threshold value used is not the threshold value from the judgment threshold value determining process, but the judgment threshold value acquired as the verification information. In other words, at this point the judgment threshold value has not been determined newly, and the judgment threshold value that was determined during the previous verification and recorded in the verification information as the value for the next verification is being used. Therefore, although the process up to verification judgment decreases, the updating process after verification judgment increases.

In Step S27, based on the result of verification judgment made in Step S26, the judgment threshold value to be used for the next verification judgment is determined by the judgment threshold value determining section 16. Therefore, Step S27 functions as the judgment threshold value determining process.

Returning at this point to FIG. 5, the process that was Step S25 in FIG. 5 has appeared here as Step S27. The point of difference is that, while the judgment threshold value was being determined in Step S25 of FIG. 5 based on the acquired verification information, in this Step S27, the new verification result is added to the verification information, and the judgment threshold value is being determined using the updated verification information. Because of this, in the verification information of the next time, a judgment threshold value taking that as a precondition has already been added as the history. In other words, the judgment threshold value for the next verification judgment has already been entered in the verification information for updating.

In Step S28, based on the verification judgment result in Step S26 and on the result of determining the judgment threshold value in Step S27, the updating processing of the registered data (biometric information, verification information) is carried out. Therefore, Step S28 functions as the biometric information registering and updating process and the verification information registering and updating process.

As has already been explained, the verification information updated in this Step S28 not only reflects the result of verification judgment, but also includes the judgment threshold value reflecting that. Because of this, at the time of the next verification judgment, it is possible to use an appropriate judgment threshold value.

In this manner, even using the verification processing flow such as that shown in FIG. 11, it is possible to obtain an effect similar to the verification processing flow shown in FIG. 5.

As has been explained above, according to the present preferred embodiment, in person verification using biometric information, by retaining the history of past verification judgment as a verification information, determining the judgment threshold value that becomes the reference for judgment based on this verification information at the time of each verification judgment, and by updating the verification information, it is possible to set the judgment threshold values appropriate for the respective biometric information. Because of this, it is possible to increase the accuracy of verification judgment in person verification, and to maintain a sufficiently high correct person acceptance rate and sufficiently high wrong person rejection rate. In addition, from the history of verification result, by deleting registered data that is not appropriate, and by determining a new registered data from registered data candidates, it is possible to maintain a still higher correct person acceptance rate.

However, the preferred embodiment of the present invention does not limit the present invention to the above preferred embodiment, and various modified forms too shall be included in the scope of the present invention as long as they conform to the intent and scope of the present invention.

What is claimed is:

1. A person verification apparatus comprising:
a first biometric information acquiring section for acquiring a first biometric information from a person who is a target of person verification;
a storage section for storing information necessary to verify the person;
a second biometric information acquiring section for acquiring a second biometric information and past verification information corresponding to the second biometric information stored in said storage section,
a threshold value determining section for determining a threshold value to be used in verification judgment based on the past verification information; and
a verification judgment section for carrying out verification judgment by comparing the degree of similarity between the first biometric information acquired by said first biometric information acquiring section and the second biometric information acquired by said second biometric information acquiring section with the threshold value determined by said threshold value determining section.

2. The person verification apparatus according to claim 1, further comprising:
a verification information updating section,
wherein said verification information updating section updates past verification information corresponding to the second biometric information stored in said storage section, based on a current result of verification judgment by said verification judgment section.

3. The person verification apparatus according to claim 1, wherein said threshold value determining section determines the threshold value based on the past verification information acquired by said second biometric information acquiring section from said storage section before carrying out verification judgment by said verification judgment section.

4. The person verification apparatus according to claim 1, wherein said threshold value determining section determines the threshold value to be used at the time of next verification judgment based on the verification information, that was updated based on a result of verification judgment, after a verification judgment carried out by said verification judgment section.

5. The person verification apparatus according to claim 1, wherein the past verification information corresponding to the second biometric information is stored in said storage section relating to the second biometric information, and the past verification information includes at least one of number of past verification trials for the second biometric information, number of past verification successes for the second biometric information, number of past verification failures for the second biometric information, past rate of verification success for the second biometric information, information representing history of threshold value, or information that can be converted mutually with these.

6. The person verification apparatus according to claim 5, wherein said threshold value determining section determines the threshold value according to the past rate of verification success as the verification information stored in the storage section.

7. The person verification apparatus according to claim 5, wherein said threshold value determining section determines whether or not to correct the threshold value according to the history of past threshold value as the verification information stored in the storage section.

8. The person verification apparatus according to claim 1, wherein said storage section stores a plurality of second biometric information corresponding to a specific person and said verification judgment section carries out verification judgment to the first biometric information using the corresponding plurality of second biometric information.

9. The person verification apparatus according to claim 8, wherein said threshold value determining section, when there is a second biometric information in the plurality of second biometric information from which appropriate threshold value can not be determined, determines to delete the second biometric information.

10. The person verification apparatus according to claim 9, wherein said storage section stores candidates for second biometric information, and further comprising:
a biometric information registering and updating section to register the candidates for second biometric information as new second biometric information when said threshold determining section determines to delete.

11. The person verification apparatus according to claim 1, wherein the first biometric information and the second biometric information are based on facial images.

12. A person verification apparatus comprising:
a threshold value determining section for determining a threshold value to be used in verification judgment;
a verification judgment section for carrying out verification judgment by comparing a first biometric information acquired from a person who is a target of person verification and a second biometric information registered in advance with the determined threshold value; and
a verification information updating section for registering verification information for use in upcoming verification judgment based on a result of current verification judgment by said verification judgment section, wherein the verification information is registered relating to the second biometric information.

13. The person verification apparatus according to claim 12, wherein the threshold value determining section determines threshold value to be used in verification judgment based on the registered verification information.

14. A person verification method comprising steps of:
acquiring a first biometric information from a person who is the target of person verification;
acquiring a second biometric information and past verification information corresponding to the second biometric information stored in a storage section;
determining a threshold value to be used in verification judgment based on the past verification information; and
carrying out verifying judgment by comparing the degree of similarity between the first biometric information and the second biometric information with the determined threshold value.

15. The person verification method according to claim 14, further comprising:
updating past verification information corresponding to the second biometric information stored in the storage section based on a result of verification judgment by the carrying out step.

16. The person verification method according to claim 14, wherein in the threshold value determining step, determine the threshold valued based on the past verification information acquired by the second biometric information acquiring step before carrying out verification judgment in the carrying out step.

17. The person verification method according to claim 14, wherein in the threshold value determining step, determine the threshold value to be used at the time of next verification judgment based on the verification information, that was updated based on a result of verification judgment, after a verification judgment carried out by said verification judgment section.

18. The person verification method according to claim 14, wherein the past verification information corresponding to the second biometric information is stored in the storage section relating to the second biometric information, and the past verification information includes at least one of number of past verification trials for the second biometric information, number of past verification successes for the second biometric information, number of past verification failures for the second biometric information, past rate of verification success for the second biometric information, information representing history of threshold value, or information that can be converted mutually with these.

19. The person verification method according to claim 18, wherein in the threshold value determining step, determine the threshold value according to past rate of verification success based on the verification information stored in the storage section.

20. The person verification method according to claim 18, wherein in the threshold value determining step, determine whether or not to correct the threshold value according to the history of past judgment threshold value based on the verification information stored in the storage section.

21. The person verification method according to claim 14, wherein the storage section stores a plurality of second biometric information corresponding to a specific person, and in the verification judgment step, carry out verification judgment to the first biometric information using the corresponding plurality of second biometric information.

22. The person verification method according to claim 21, wherein in the threshold value determining step, when there is a second biometric information in the plurality of second biometric information from which appropriate threshold value can not be determined, determine to delete the second biometric information.

23. The person verification method according to claim 22, wherein the storage section stores candidates for second biometric information, and further comprising:
registering the candidates for second biometric information as new second biometric information when said threshold determining section determines to delete.

24. The person verification method according to claim 14, wherein the first biometric information and the second biometric information are based on facial images.
